(19) United States
(12) Patent Application Publication
(10) Pub. No.: US 2002/0184036 A1
(43) Pub. Date: Dec. 5, 2002

(54) Apparatus and method for visible indication of speech

(76) Inventor: Nachshon Margaliot, Elkana (IL)

Correspondence Address: HAHN LOESER & PARKS, LLP, TWIN OAKS ESTATE, 1225 W. MARKET STREET, AKRON, OH, 44313, US

(21) Appl. No.: 10/148,378

(22) PCT Filed: Dec. 1, 2000
(86) PCT No.: PCT/IL00/00809

(30) Foreign Application Priority Data
Dec. 29, 1999 (IL) 133797

(51) Int. Cl. G10L 21/06

(52) U.S. Cl. 704/276

(57) ABSTRACT

This invention discloses a system and method for providing a visible indication of speech, the system including a speech analyzer operative to receive input speech (10), and to provide a phoneme-based output indication (14) representing the input speech, and a visible display receiving the phoneme-based output indication (16) and providing an animated representation of the input speech based on the phoneme-based output indication (16).

### FIELD OF THE INVENTION

The present invention relates generally to systems and methods for visible indication of speech.

### BACKGROUND OF THE INVENTION

Various systems and methods for visible indication of speech exist in the patent literature. The following U.S. Patents are believed to represent the state of the art: U.S. Pat. Nos. 4,884,972; 5,278,943; 5,630,017; 5,689,618; 5,734,794; 5,878,396 and 5,923,337. U.S. Pat. No. 5,923,337 is believed to be the most relevant and its disclosure is hereby incorporated by reference.

### SUMMARY OF THE INVENTION

The present invention seeks to provide improved systems and methods for visible indication of speech.

There is thus provided in accordance with a preferred embodiment of the present invention a system for providing a visible indication of speech, the system including:

a speech analyzer operative to receive input speech and to provide a phoneme-based output indication representing the input speech; and

a visible display receiving the phoneme-based output indication and providing an animated representation of the input speech based on the phoneme-based output indication.

There is also provided in accordance with a preferred embodiment of the present invention a system for providing a visible indication of speech, the system including:

a speech analyzer operative to receive input speech and to provide an output indication representing the input speech; and

a visible display receiving the output indication and providing an animated representation of the input speech based on the output indication, the animated representation including features not normally visible during human speech.

There is additionally provided in accordance with a preferred embodiment of the present invention a system for providing a visible indication of speech, the system including:

a speech analyzer operative to receive input speech of a speaker and to provide an output indication representing the input speech; and

a visible display receiving the output indication and providing an animated representation of the input speech based on the output indication, the animated representation including indications of at least one of speech volume, the speaker's emotional state and the speaker's intonation.

There is further provided in accordance with a preferred embodiment of the present invention a system for providing speech compression, the system including:

a speech analyzer operative to receive input speech and to provide a phoneme-based output indication representing the input speech in a compressed form.

There is also provided in accordance with a preferred embodiment of the present invention a method for providing a visible indication of speech, the method including:

speech analysis operative to receive input speech and to provide a phoneme-based output indication representing the input speech; and

receiving the phoneme-based output indication and providing an animated representation of the input speech based on the phoneme-based output indication.

There is also provided in accordance with a preferred embodiment of the present invention a method for providing a visible indication of speech, the method including:

speech analysis operative to receive input speech and to provide an output indication representing the input speech; and

receiving the phoneme-based output indication and providing an animated representation of the input speech based on the phoneme-based output indication, the animated representation including features not normally visible during human speech.

There is additionally provided in accordance with a preferred embodiment of the present invention a method for providing a visible indication of speech, the method including:

speech analysis operative to receive input speech of a speaker and to provide an output indication representing the input speech; and

receiving the phoneme-based output indication and providing an animated representation of the input speech based on the phoneme-based output indication, the animated representation including indications of at least one of speech volume, the speaker's emotional state and the speaker's intonation.

There is further provided in accordance with a preferred embodiment of the present invention a method for providing speech compression, the method including:

receiving input speech and providing a phoneme-based output indication representing the input speech in a compressed form.

The system and method of the present invention may be employed in various applications, such as, for example, a telephone for the hearing impaired, a television for the hearing impaired, a movie projection system for the hearing impaired and a system for teaching persons how to speak.

### BRIEF DESCRIPTION OF TEE DRAWINGS

The present invention will be understood and appreciated more filly from the following detailed description, taken on conjunction with the drawings in which:

FIG. 1 is a simplified pictorial illustration of a telephone communication system for the hearing impaired, constructed and operative in accordance with a preferred embodiment of the present invention;

FIG. 2 is a simplified pictorial illustration of a television for the hearing impaired, constructed and operative in accordance with a preferred embodiment of the present invention;

FIGS. 3A and 3B are simplified pictorial illustrations of two typical embodiments of a communication assist device for the hearing impaired, constructed and operative in accordance with a preferred embodiment of the present invention;

FIG. 4 is a simplified pictorial illustration of a radio for the hearing impaired, constructed and operative in accordance with a preferred embodiment of the present invention;

FIG. 5 is a simplified pictorial illustration of a television set top comprehension assist device for the hearing impaired, constructed and operative in accordance with a preferred embodiment of the present invention;

FIG. 6 is a simplified block diagram of a system for providing a visible indication of speech, constructed and operative in accordance with a preferred embodiment of the present invention;

FIG. 7 is a simplified flow chart of a method for providing a visible indication of speech, operative in accordance with a preferred embodiment of the present invention;

FIG. 8 is a simplified pictorial illustration of a telephone for use by persons having impaired hearing; and

FIG. 9 is a simplified pictorial illustration of broadcast of a television program for a hearing impaired viewer.

### DETAILED DESCRIPTION OF PREFERRED EMBODIMENTS

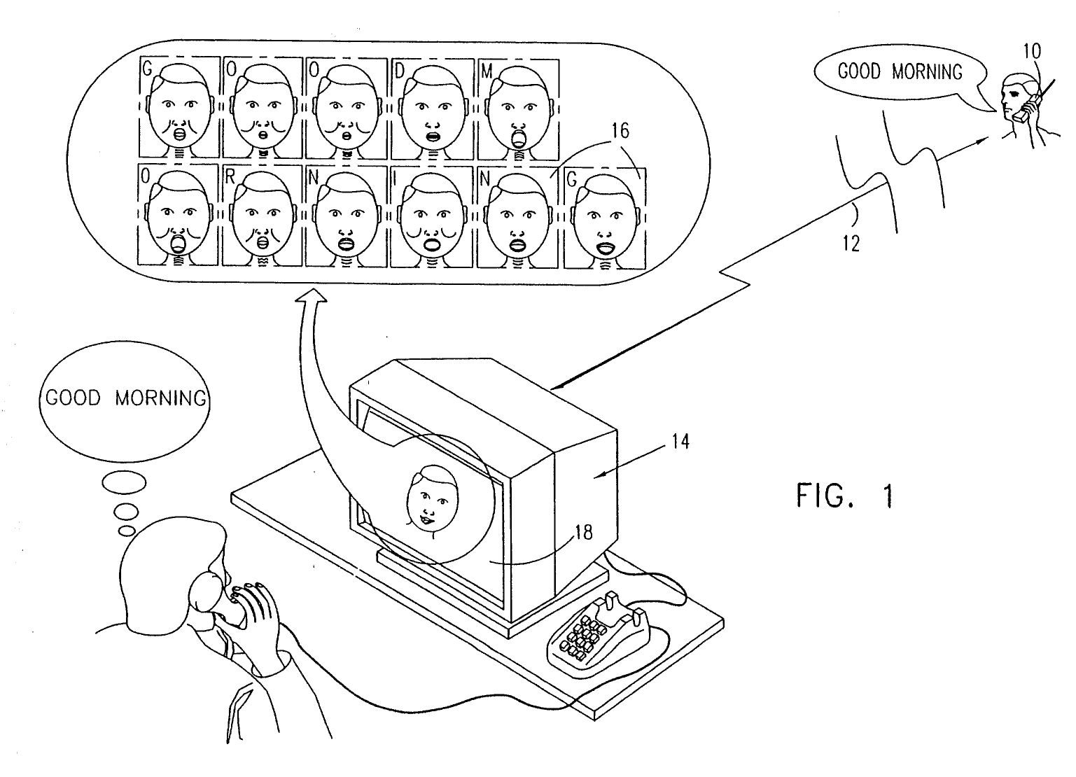

Reference is now made to FIG. 1, which is a simplified pictorial illustration of a telephone communication system for the hearing impaired, constructed and operative in accordance with a preferred embodiment of the present invention. As seen in FIG. 1, speech of a remote speaker speaking on a conventional telephone 10 via a conventional telephone link 12 is received at a telephone display device 14, which analyzes the speech and converts it, preferably in real time, to a series of displayed animations 16, which correspond to the phonemes of the received speech. These phonemes are viewed by a user on screen 18 and assist the user, who may have hearing impairment, in understanding the input speech.

In accordance with a preferred embodiment of the present invention the animated representation, as seen, for example in FIG. 1 includes features, such as operation of the throat, nose and tongue inside the mouth, not normally visible during human speech. Further in accordance with a preferred embodiment of the present invention, as seen, for example in FIG. 1, the animated representation includes indications of at least one of the speech volume, the speaker's emotional state and the speaker's intonation.

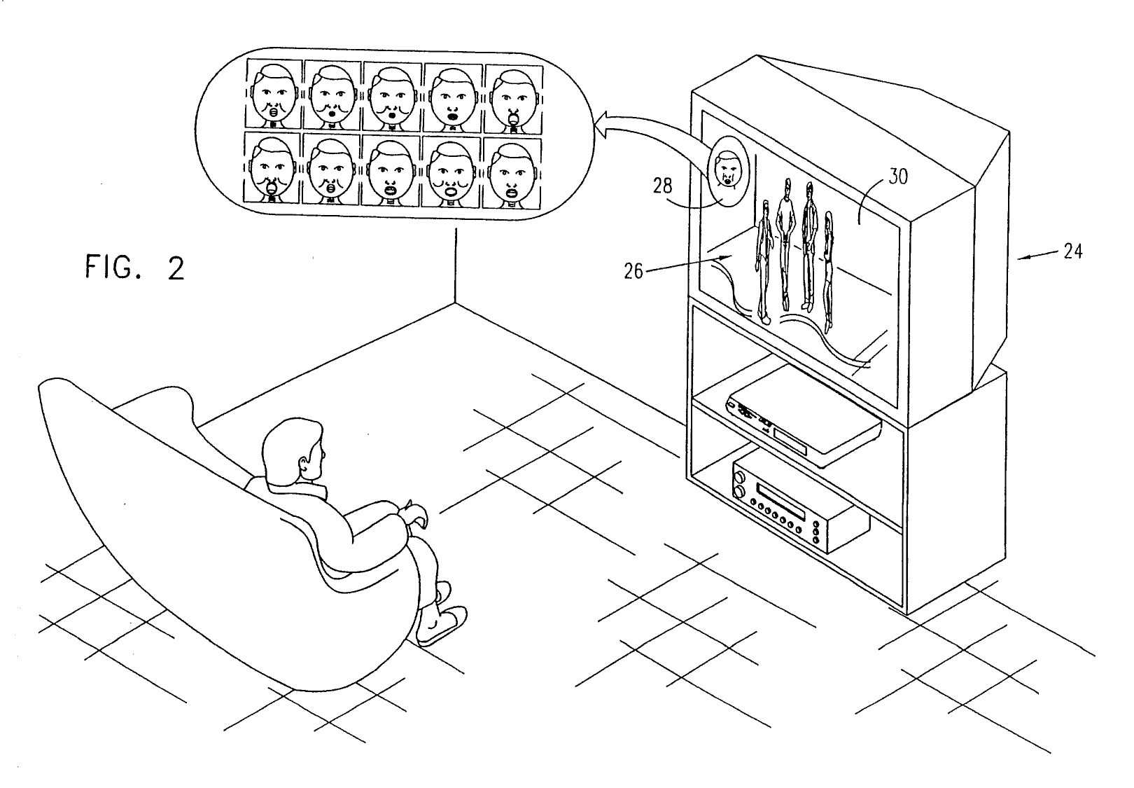

Reference is now made to FIG. 2, which is a simplified pictorial illustration of a television for the hearing impaired, constructed and operative in accordance with a preferred embodiment of the present invention. As indicated in FIG. 2, the television can be employed by a user for receiving broadcast programs as well as for playing pre-recorded tapes or discs.

As seen in FIG. 2, speech of a speaker in the broadcast or pre-recorded content being seen or played is received at a television display device 24, which analyzes the speech and converts it, preferably in real time, to a series of displayed animations 26, which correspond to the phonemes of the received speech. These phonemes are viewed by a user and assist the user, who may have hearing impairment, in understanding the speech. The animations are typically displayed adjacent a corner 28 of a screen 30 of the display device 24.

In accordance with a preferred embodiment of the present invention the animated representation, as seen, for example in FIG. 2 includes features, such as operation of the throat, nose and tongue inside mouth, not normally visible during human speech. Further in accordance with a preferred embodiment of the present invention, as seen, for example in FIG. 2, the animated representation includes indications of at least one of the speech volume, the speaker's emotional state and the speaker's intonation.

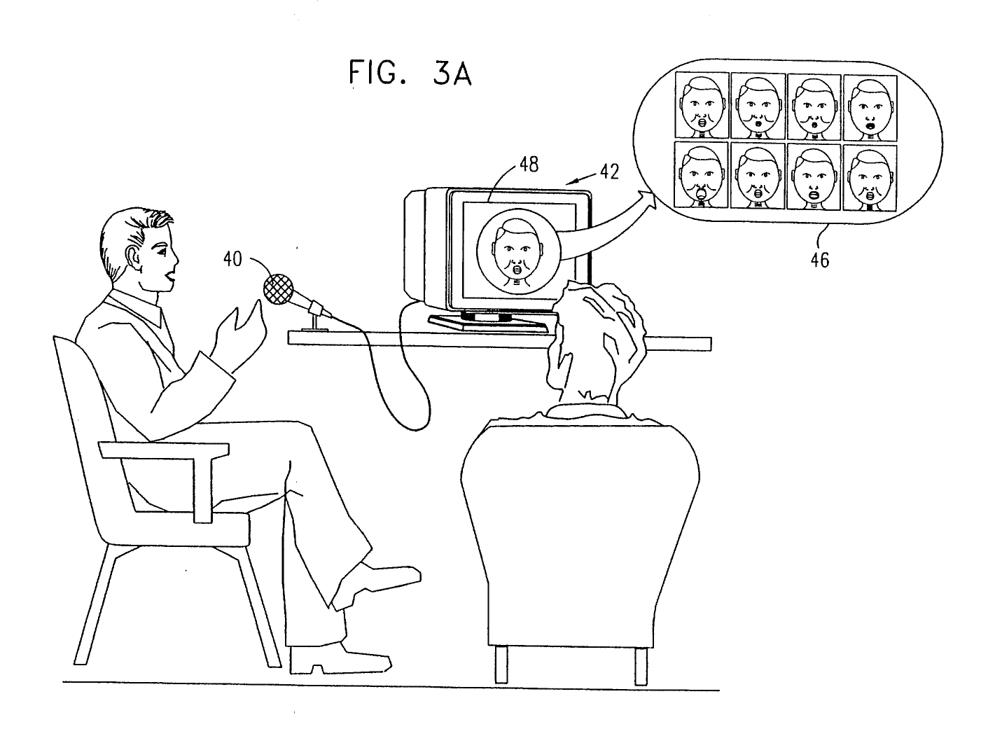

Reference is now made to FIGS. 3A and 3B, which are simplified pictorial illustrations of two typical embodiments of a communication assist device for the hearing impaired, constructed and operative in accordance with a preferred embodiment of the present invention. As seen in FIG. 3A, speech of a speaker is captured by a conventional microphone 40 and is transmitted by wire to an output display device 42, which analyzes the speech and converts it, preferably in real time, to a series of displayed animations 46, which correspond to the phonemes of the received speech. These phonemes are viewed by a user on screen 48 and assist the user, who may have hearing impairment, in understanding the input speech.

FIG. 3B shows speech of a speaker being captured by a conventional lapel microphone 50 and is transmitted wirelessly to an output display device 52, which analyzes the speech and converts it, preferably in real time, to a series of displayed animations 56, which correspond to the phonemes of the received speech. These phonemes are viewed by a user on screen 58 and assist the user, who may have hearing impairment, in understanding the input speech.

In accordance with a preferred embodiment of the present invention the animated representation, as seen, for example in FIGS. 3A & 3B includes features, such as operation of the throat, nose and tongue inside mouth, not normally visible during human speech. Further in accordance with a preferred embodiment of the present invention, as seen, for example in FIGS. 3A & 3B, the animated representation includes indications of at least one of the speech volume, the speaker's emotional state and the speaker's intonation.

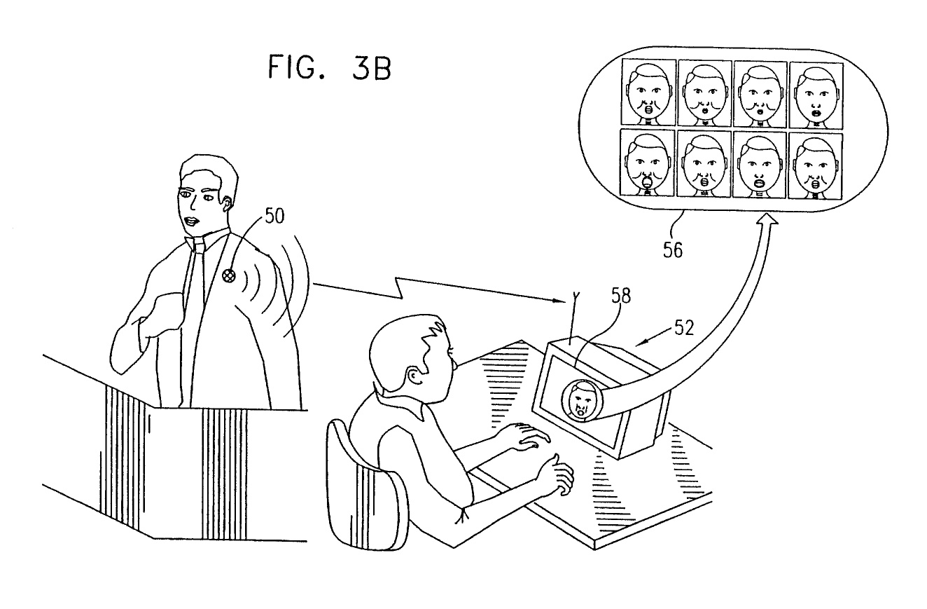

Reference is now made to FIG. 4, which is a simplified pictorial illustration of a radio for the hearing impaired, constructed and operative in accordance with a preferred embodiment of the present invention.

As seen in FIG. 4, speech of a speaker in the broadcast content being heard is received at a radio speech display device 64, which analyzes the speech and converts it, preferably in real time, to a series of displayed animations 66, which correspond to the phonemes of the received speech. These phonemes are viewed by a user and assist the user, who may have hearing impairment, in understanding the speech. The animations are typically displayed on a screen 70 of the display device 64. The audio portion of the radio transmission may be played simultaneously.

In accordance with a preferred embodiment of the present invention the animated representation, as seen, for example in FIG. 4 includes features, such as operation of the throat, nose and tongue inside mouth, not normally visible during human speech. Further in accordance with a preferred embodiment of the present invention, as seen, for example in FIG. 2, the animated representation includes indications of at least one of the speech volume, the speaker's emotional state and the speaker's intonation.

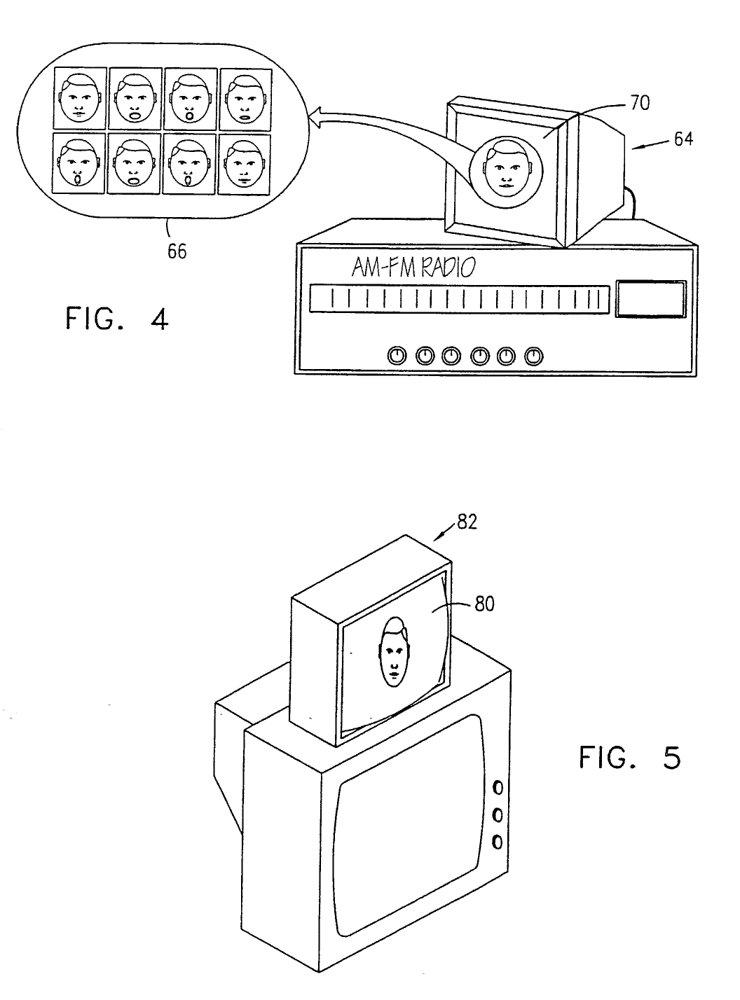

Reference is now made to FIG. 5, which is a simplified pictorial illustration of a television set top comprehension assist device for the hearing impaired, constructed and operative in accordance with a preferred embodiment of the present invention. The embodiment of FIG. 5 may be identical to that of FIG. 2 except in that it includes a separate screen 80 and speech analysis apparatus 82 which may be located externally of a conventional television receiver and viewed together therewith.

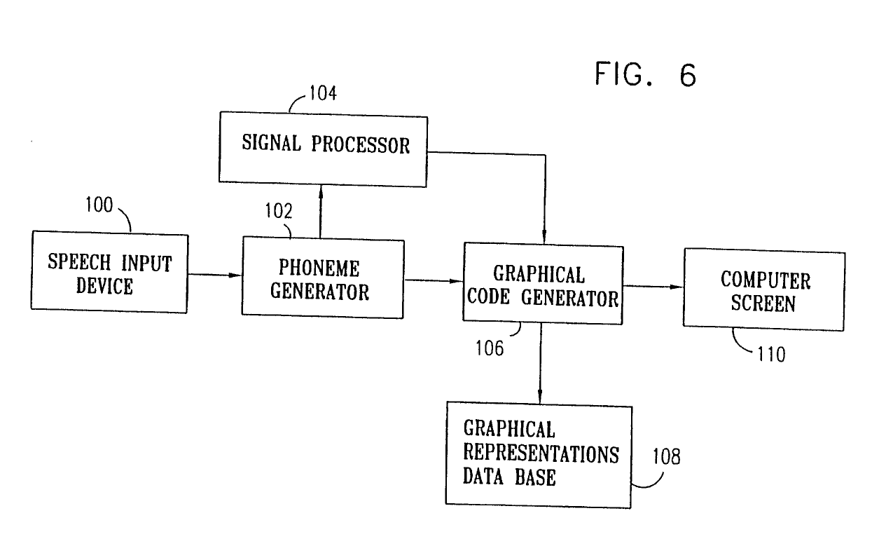

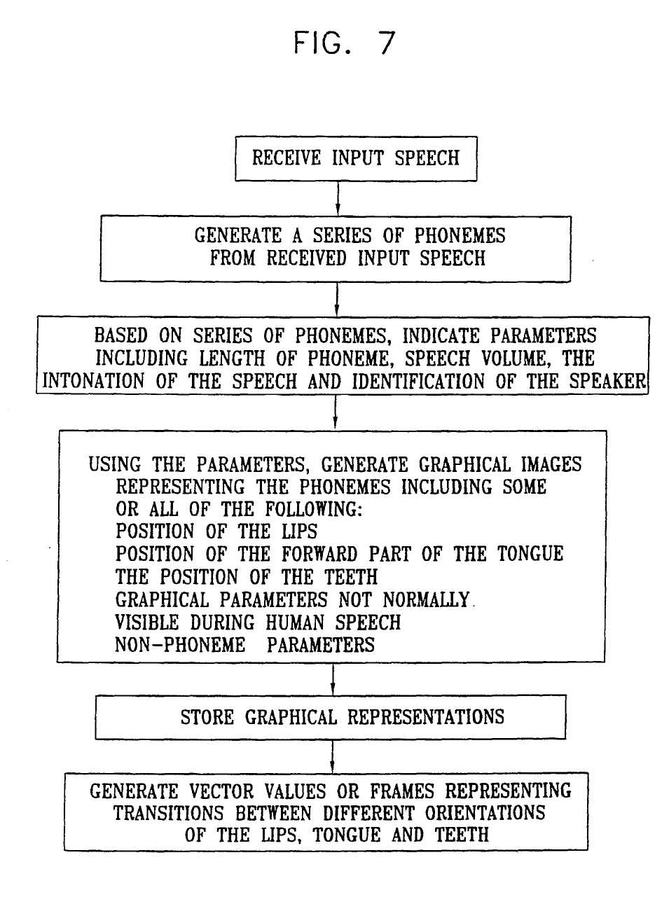

Reference is now made to FIG. 6, which is a simplified block diagram of a system for providing a visible indication of speech, constructed and operative in accordance with a preferred embodiment of the present invention and to FIG. 7, which is a flowchart of the operation of such a system.

The system shown in FIG. 6 comprises a speech input device 100, such as a microphone or any other suitable speech input device, for example, a telephone, television receiver, radio receiver or VCR. The output of speech input device 100 is supplied to a phoneme generator 102 which converts the output of speech input device 100 into a series of phonemes. The output of generator 102 is preferably supplied in parallel to a signal processor 104 and to a graphical code generator 106. The signal processor 104 provides at least one output indicating parameters. such as the length of a phoneme, the speech volume, the intonation of the speech and identification of the speaker.

Graphical representation generator 106 preferably receives the output from signal processor 104 as well as the output of phoneme generator 102 and is operative to generate a graphical image representing the phonemes. This graphical image preferably represents some or all of the following parameters:

The position of the lips—There are typically 11 different lip position configurations, including five lip position configurations when the mouth is open during speech, five lip position configurations when the mouth is closed during speech and one rest position;

The position of the forward part of the tongue—There are three positions of the forward part of the tongue.

The position of the teeth—There are four positions of the teeth.

In accordance with a preferred embodiment of the present invention, the graphical image preferably represents at least one of the following parameters which are not normally visible during human speech:

The position of the back portion of the tongue—

The orientation of the cheeks for Plosive phonemes—

The orientation of the throat for Voiced phonemes—

The orientation of the nose for Nasal Phonemes—

Additionally in accordance with a preferred embodiment of the present invention, the graphical image preferably represents one or more of the following non-phoneme parameters:

The volume of the speech—

The intonation of the speech—

An identification of the speaker—

The length of the phoneme—This can be used for distinguishing certain phonemes from each other, such as “bit” and “beat”.

The graphical representation generator 106 preferably cooperates with a graphical representations store 108, which stores the various representations, preferably in a modular format. Store 1(8 preferably stores not only the graphical representations of the phonemes but also the graphical representations of the non-phoneme parameters and non-visible parameters described hereinabove.

In accordance with a preferred embodiment of the present invention, vector values or frames, which represent transitions between different orientations of the lips, tongue and teeth, are generated. This is a highly efficient technique which makes real time display of speech animation possible in accordance with the present invention.

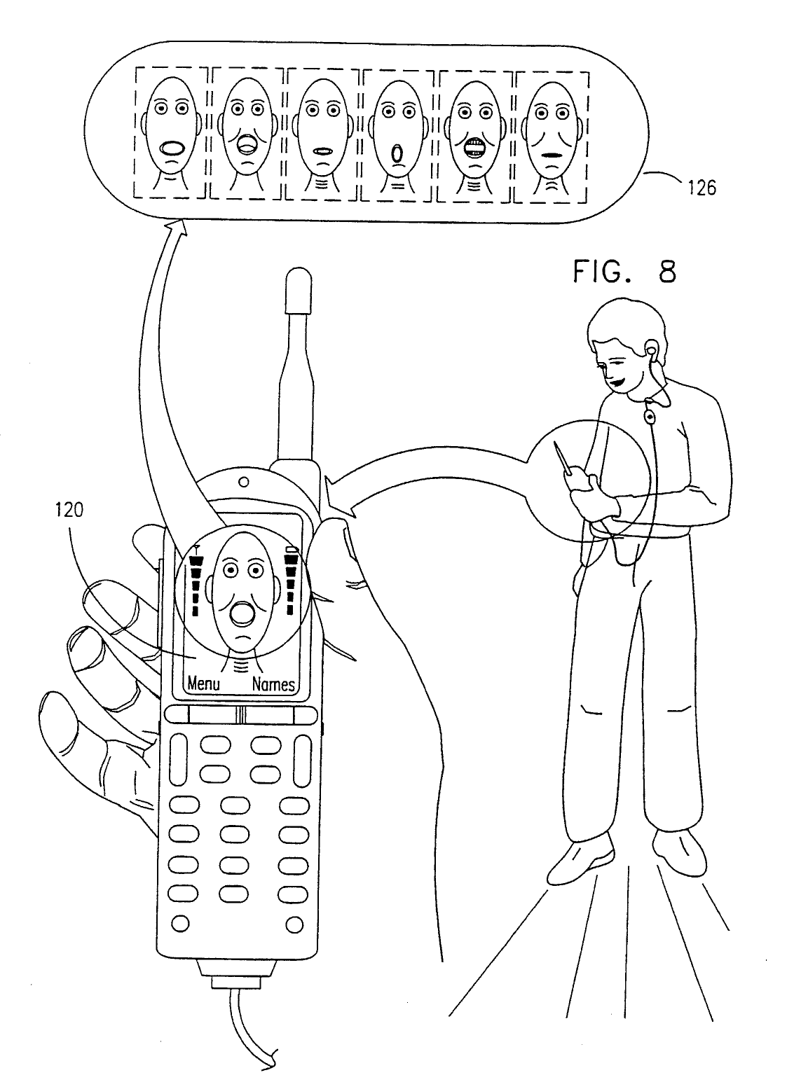

Reference is now made to FIG. 8, which illustrates a telephone for use by a hearing impaired person. It is seen in FIG. 8, that a conventional display 120 is used for displaying a series of displayed animations 126, which correspond to the phonemes of the received speech. These phonemes are viewed by a user and assist the user, who may have hearing impairment, in understanding the speech.

In accordance with a preferred embodiment of the present invention the animated representation, as seen, for example in FIG. 8 includes features, such as operation of the throat, nose and tongue inside the mouth, not normally visible during human speech. Further in accordance with a preferred embodiment of the present invention, as seen, for example in FIG. 8, the animated representation includes indications of at least one of the speech volume, the speaker's emotional state and the speaker's intonation.

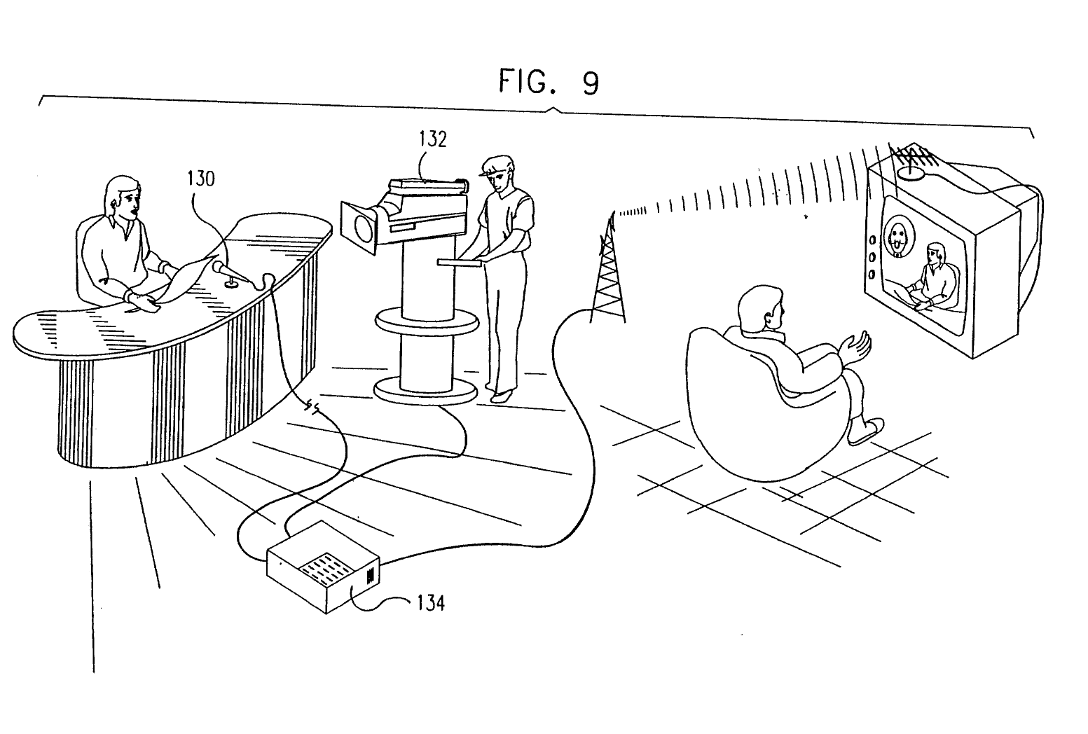

Reference is now made to FIG. 9, which illustrates a system for broadcast of television content for the hearing impaired. In an otherwise conventional television studio, a microphone 130 and a camera 132 preferably output to an interface 134 which typically includes the structure of FIG. 6 and the functionality of FIG. 7. The output of interface 134 is supplied as a broadcast feed.

It will be appreciated by persons skilled in the art that the present invention is not limited by what has been particularly shown and described hereinabove. Rather the scope of the present invention includes both combinations and subcombinations of various features described hereinabove and in the drawings as well as modifications and variations thereof which would occur to a person of ordinary skill in the art upon reading the foregoing description and which are not in the prior art.

1. A system for providing a visible indication of speech, the system including:
a speech analyzer operative to receive input speech and to provide a phoneme-based output indication representing the input speech; and
a visible display receiving the phoneme-based output indication and providing an animated representation of the input speech based on the phoneme-based output indication.

2. A system according to claim 1 which is implemented as part of a radio for enabling persons with hearing disabilities to comprehend radio broadcasts.

3. A system according to claim 1 which is implemented as part of a television for enabling persons with hearing disabilities to comprehend the speech portion of television broadcasts.

4. A system according to claim 1 which is implemented as part of a movie playing system for enabling persons with hearing disabilities to comprehend a speech portion of a movie being played.

5. A system according to claim 1 which is implemented as part of a system for teaching persons how to speak.

6. A system according to claim 1 which is implemented as part of a telephone for enabling persons with hearing disabilities to comprehend a speech portion of a telephone conversation.

7. A system according to claim 1 connected to a television so as to be viewable together therewith for enabling persons with hearing disabilities to comprehend the speech portion of television broadcasts.

8. A system according to claim 1 connected to a microphone for enabling persons with hearing disabilities to comprehend the speech of a person speaking into the microphone.

9. A system according to claim 1 and wherein said animated representation includes indications of at least one of speech volume, the speaker's emotional state and the speaker's intonation.

10. A system according to claim 9 and wherein said animated representation includes features not normally visible during human speech.

11. A system for providing a visible indication of speech, the system including:
a speech analyzer operative to receive input speech and to provide an output indication representing the input speech; and
a visible display receiving the output indication and providing an animated representation of the input speech based on the output indication, the animated representation including features not normally visible during human speech.

12. A system according to claim 11 which is implemented as part of a radio for enabling persons with hearing disabilities to comprehend radio broadcasts.

13. A system according to claim 11 which is implemented as part of a television for enabling persons with hearing disabilities to comprehend the speech portion of television broadcasts.

14. A system according to claim 11 which is implemented as part of a movie playing system for enabling persons with hearing disabilities to comprehend a speech portion of a movie being played.

15. A system according to claim 11 which is implemented as part of a system for teaching persons how to speak.

16. A system according to claim 11 which is implemented as part of a telephone for enabling persons with hearing disabilities to comprehend a speech portion of a telephone conversation.

17. A system according to claim 11 connected to a television so as to be viewable together therewith for enabling persons with hearing disabilities to comprehend the speech portion of television broadcasts.

18. A system according to claim 11 connected to a microphone for enabling persons with hearing disabilities to comprehend the speech of a person speaking into the microphone.

19. A system according to claim 12 and wherein said analyzer is operative to receive input speech and to provide a phoneme-based output indication representing the input speech.

20. A system according to claim 19 and wherein said animated representation includes features not normally visible during human speech.

21. A system for providing a visible indication of speech, the system including:
a speech analyzer operative to receive input speech of a speaker and to provide an output indication representing the input speech; and
a visible display receiving the output indication and providing an animated representation of the input speech based on the output indication, the animated representation including indications of at least one of speech volume, the speaker's emotional state and the speaker's intonation.

22. A system according to claim 21 which is implemented as part of a radio for enabling persons with hearing disabilities to comprehend radio broadcasts.

23. A system according to claim 21 which is implemented as part of a television for enabling persons with hearing disabilities to comprehend the speech portion of television broadcasts.

24. A system according to claim 21 which is implemented as part of a movie playing system for enabling persons with hearing disabilities to comprehend a speech portion of a movie being played.

25. A system according to claim 21 which is implemented as part of a system for teaching persons how to speak.

26. A system according to claim 21 which is implemented as part of a telephone for enabling persons with hearing disabilities to comprehend a speech portion of a telephone conversation.

27. A system according to claim 21 connected to a television so as to be viewable together therewith for enabling persons with hearing disabilities to comprehend the speech portion of television broadcasts.

28. A system according to claim 21 connected to a microphone for enabling persons with hearing disabilities to comprehend the speech of a person speaking into the microphone.

29. A system according to claim 21 and wherein said analyzer is operative to receive input speech and to provide a phoneme-based output indication representing the input speech.

30. A system according to claim 29 and wherein said analyzer is operative to receive input speech and to provide a phoneme-based output indication representing the input speech.

31. A system for providing speech compression, the system including:
a speech analyzer operative to receive input speech and to provide a phoneme-based output indication representing the input speech in a compressed form.

32. A system according to claim 31 which is implemented as part of a radio for enabling persons with hearing disabilities to comprehend radio broadcasts.

33. A system according to claim 31 which is implemented as part of a television for enabling persons with hearing disabilities to comprehend the speech portion of television broadcasts.

34. A system according to claim 31 which is implemented as part of a movie playing system for enabling persons with hearing disabilities to comprehend a speech portion of a movie being played.

35. A system according to claim 31 which is implemented as part of a system for teaching persons how to speak.

36. A system according to claim 31 which is implemented as part of a telephone for enabling persons with hearing disabilities to comprehend a speech portion of a telephone conversation.

37. A system according to claim 31 connected to a television so as to be viewable together therewith for enabling persons with hearing disabilities to comprehend the speech portion of television broadcasts.

38. A system according to claim 31 connected to a microphone for enabling persons with hearing disabilities to comprehend the speech of a person speaking into the microphone.

39. A system according to claim 31 and wherein said analyzer is operative to receive input speech and to provide a phoneme-based output indication representing the input speech.

40. A system according to claim 39 and wherein said animated representation includes features not normally visible during human speech.

41. A method for providing a visible indication of speech, the method including:
conducting speech analysis operative on received input speech and providing a phoneme-based output indication representing the input speech; and
receiving the phoneme-based output indication and providing an animated representation of the input speech based on the phoneme-based output indication.

42. A method according to claim 41 which is implemented as part of a radio for enabling persons with hearing disabilities to comprehend radio broadcasts.

43. A method according to claim 41 which is implemented as part of a television for enabling persons with hearing disabilities to comprehend the speech portion of television broadcasts.

44. A method according to claim 41 which is implemented as part of a movie playing system for enabling persons with hearing disabilities to comprehend a speech portion of a movie being played.

45. A method according to claim 41 which is implemented as part of a system for teaching persons how to speak.

46. A method according to claim 41 which is implemented as part of a telephone for enabling persons with hearing disabilities to comprehend a speech portion of a telephone conversation.

47. A method according to claim 41 connected to a television so as to be viewable together therewith for enabling persons with hearing disabilities to comprehend the speech portion of television broadcasts.

48. A method according to claim 41 connected to a microphone for enabling persons with hearing disabilities to comprehend the speech of a person speaking into the microphone.

49. A method according to claim 41 and wherein said animated representation includes indications of at least one of speech volume, the speaker's emotional state and the speaker's intonation.

50. A method according to claim 49 and wherein said animated representation includes features not normally visible during human speech.

51. A method for providing a visible indication of speech, the method including:
conducting speech analysis on received input speech and providing an output indication representing the input speech; and
receiving the output indication and providing an animated representation of the input speech based on the output indication, the animated representation including features not normally visible during human speech.

52. A method according to claim 51 which is implemented as part of a radio for enabling persons with hearing disabilities to comprehend radio broadcasts.

53. A method according to claim 51 which is implemented as part of a television for enabling persons with hearing disabilities to comprehend the speech portion of television broadcasts.

54. A method according to claim 51 which is implemented as part of a movie playing system for enabling persons with hearing disabilities to comprehend a speech portion of a movie being played.

55. A method according to claim 51 which is implemented as part of a system for teaching persons how to speak.

56. A method according to claim 51 which is implemented as part of a telephone for enabling persons with hearing disabilities to comprehend a speech portion of a telephone conversation.

57. A method according to claim 51 connected to a television so as to be viewable together therewith for enabling persons with hearing disabilities to comprehend the speech portion of television broadcasts.

58. A method according to claim 51 connected to a microphone for enabling persons with hearing disabilities to comprehend the speech of a person speaking into the microphone.

59. A method according to claim 51 and wherein said analyzer is operative to receive input speech and to provide a phoneme-based output indication representing the input speech.

60. A method according to claim 59 and wherein said analyzer is operative to receive input speech and to provide a phoneme-based output indication representing the input speech.

61. A method for providing a visible indication of speech, the method including:
conducting speech analysis on received input speech of a speaker and providing an output indication representing the input speech; and
receiving the output indication and providing an animated representation of the input speech based on the output indication, the animated representation including indications of at least one of speech volume, the speaker's emotional state and the speaker's intonation.

62. A method according to claim 61 which is implemented as part of a radio for enabling persons with hearing disabilities to comprehend radio broadcasts.

63. A method according to claim 61 which is implemented as part of a television for enabling persons with hearing disabilities to comprehend the speech portion of television broadcasts.

64. A method according to claim 61 which is implemented as part of a movie playing system for enabling persons with hearing disabilities to comprehend a speech portion of a movie being played.

65. A method according to claim 61 which is implemented as part of a system for teaching persons how to speak.

66. A method according to claim 61 which is implemented as part of a telephone for enabling persons with hearing disabilities to comprehend a speech portion of a telephone conversation.

67. A method according to claim 61 connected to a television so as to be viewable together therewith for enabling persons with hearing disabilities to comprehend the speech portion of television broadcasts.

68. A method according to claim 61 connected to a microphone for enabling persons with hearing disabilities to comprehend the speech of a person speaking into the microphone.

69. A method according to claim 62 and wherein said analyzer is operative to receive input speech and to provide a phoneme-based output indication representing the input speech.

70. A method according to claim 69 and wherein said animated representation includes features not normally visible during human speech.

71. A method for providing speech compression, the method including:
receiving and analyzing input speech; and
providing a phoneme-based output indication representing the input speech in a compressed form.
